(19) United States
(12) Patent Application Publication
(10) Pub. No.: US 2020/0400253 A1
(43) Pub. Date: Dec. 24, 2020

(54) MULTIPLE LAYER MOTOR VEHICLE HOSE LINE

(71) Applicant: TI Automotive (Fuldabrück) GmbH, Fuldabrück (DE)

(72) Inventors: Werner Zimmer, Melsungen/Roehrenfurth (DE); Frank Fahrenholz, Kassel (DE); Siegfried Arnold, Kassel (DE)

(21) Appl. No.: 16/975,051

(22) PCT Filed: Feb. 21, 2019
(86) PCT No.: PCT/IB2019/051434

§ 371 Date: Aug. 21, 2020

(30) Foreign Application Priority Data
Feb. 22, 2018 (EP) 18158180.2
May 9, 2018 (EP) 18171614.3

(51) Int. Cl. F16L 11/10; B32B 1/08; B32B 27/08; B32B 7/12

(52) U.S. Cl. CPC F16L 11/10; B32B 1/08; B32B 27/08; B32B 2325/00; B32B 2597/00; B32B 2307/732; B32B 2377/00; B32B 7/12

(57) ABSTRACT

Multi-layer motor vehicle tube for conducting at least one fluid medium, in particular for conducting of motor fuels, wherein the tube comprises at least five layers, The tube features the following layer structure, from outside to inside: an outside layer made of at least one polyamide, a first adhesion-promoting layer, a barrier layer with barrier properties, a second adhesion-promoting layer, an inside layer made of at least one thermoplastic polyurethane (TPU) and/or at least one partly aromatic polyamide (PPA). The total layer thickness of the tube amounts to 0.7 to 3 mm.

### RELATED APPLICATIONS

The present patent document claims priority to PCT Application PCT/162019/051434, filed Feb. 21, 2019, which claims the benefit of and priority to European Patent Applications 18 171 614.3, filed May 9, 2018 entitled “Multiple Layer Motor Vehicle Hose Line”, and 18 158 180.2 entitled “Multiple Layer Motor Vehicle Hose Line”, filed Feb. 22, 2018, and entitled “Multiple Layer Motor Vehicle Hose Line”, the entire contents both of which are incorporated herein by reference.

### FIELD

The disclosure relates to a multiple-layer motor vehicle tube for conducting of a fluid medium, in particular for conducting of motor fuels, wherein the tube features at least five layers. The multiple-layer motor vehicle tube according to the disclosure is employed in particular as a motor fuel tube in vehicles and/or motor vehicles. Basically the motor vehicle tube can also be employed as a ventilation line in tank ventilating systems. In this usage, the tube is exposed in particular to fuel vapors and their condensates. In principle, the invented motor vehicle tube can also be used for other purposes, for example as a line for coolant and tempering media.

### BACKGROUND

Multi-layer motor vehicle tubes of the kind described above are known in various design formats in the prior art. Many of these known tubes have the disadvantage that when conducting the motor fuel, they are exposed to undesirable wash-out of tube components. This applies especially to the inside layer standing in contact with the motor fuel, but also to the adjoining, middle layers. In many known motor vehicle tubes, oligomers and similar harmful constituents are washed out from the layers by the fuel and these substances precipitate in an adverse manner in the fuel system. This can cause problems especially on nozzles and similar components. For these reasons, many known tubes leave much to be desired in regard to their resistance to the fuels. Consequently, the barrier properties of these tubes also often do not satisfy the requirements. In the past, attempts were made to solve this problem by using different variation of the layers in particular of the inside layers. But improvements in regard to undesirable wash-out led to other disadvantages, namely to a reduced mechanical resistance and/or to a reduced thermal resistance and/or to a reduced resistance to other corrosive factors. Different tubes that were used to solve this stated problem are also relatively expensive due to their choice of materials. To this extent, improvements are needed.

### SUMMARY

The disclosure is based on the technical problem of specifying a multiple-layer motor vehicle tube of the kind stated above, in which the disadvantages described above can be effectively avoided and which, above all, displays an improved resistance to wash-out and additionally exhibits a sufficient mechanical resistance and also an optimum thermal resistance. Moreover, the multiple-layer motor vehicle tube should also have sufficient resistance to external corrosive influences and/or to corrosive media for example, to metal chlorides.

To solve the technical problem, the disclosure presents a multi-layer motor vehicle tube for conducting of a fluid medium, in particular for conducting of motor fuels, wherein the tube features at least five layers and specifically with the following layer structure, from outside to inside:
an outside layer made of at least one polyamide,
a first adhesion-promoting layer,
a barrier layer with barrier properties against at least one component of the fluid medium,
a second adhesive layer,
an inside layer made of at least one thermoplastic polyurethane (TPU) and/or of at least one partly aromatic polyamide (PPA),

wherein the total layer thickness of the tube amounts to 0.7 to 2.5 mm, preferably 0.8 to 2 mm, and most preferably 0.85 to 1.8 mm.

It remains within the scope of the disclosure that an outside layer of at least one polyamide is provided. The outside layer made of at least one polyamide, within the framework of the disclosure, means that the outside layer consists of at least one polyamide and/or substantially of at least one polyamide. One particularly preferred embodiment of the disclosure is characterized in that the outside layer consists of polyamide 12 and/or of polyamide 6.12 and/or substantially of polyamide 12 and/or of polyamide 6.12. It is recommended that the thickness of the outside layer amounts to 5 to 50%, in particular 5 to 45%, and preferably 7 to 40% of the total layer thickness of the tube. It is recommended that the maximum thickness of the outside layer amounts to 0.4 mm. It is expedient that the thickness of the outside layer be between 0.1 and 0.4 mm, preferably between 0.2 and 0.4 mm.

According to the disclosure, at least one first adhesion-promoting layer is provided between the outside layer and the barrier layer. According to one proven embodiment, solely the first adhesion-promoting layer is arranged between the outside layer and barrier layer, and herein the first adhesion-promoting layer is bonded directly to the outside layer on the one side, and directly to the barrier layer on the other side. It is expedient to use an adhesion-promoting layer based on at least one polyamide and/or based on at least one polyolefin. If an adhesion-promoting layer based on polyamide is used, then the recommendation is to use a modified polyamide, and specifically preferred is a modified polyamide based on polyamide 6.12. When using a first adhesion-promoting layer based on a polyolefin, it is recommended to use an adhesion-promoting layer based on polypropylene. In the case of polypropylene, preferably recommended is a modified polypropylene which is modified, for example, with a carbonic acid derivative.—It remains within the scope of the disclosure that the thickness of the first adhesion-promoting layer amounts to 3 to 30%, preferably 5 to 20%, and preferably 5 to 15% of the total layer thickness of the tube. The thickness of the first adhesion-promoting layer expediently amounts to 0.03 to 0.15 mm, and preferably 0.03 to 0.1 mm.

One particularly preferred embodiment of the disclosure is characterized in that the barrier layer is a barrier layer based on at least one component from the group “EVOH, fluoropolymer.” In this regard, EVOH means ethylene-Vinyl alcohol-Copolymer. According to a first embodiment, the barrier layer consists of EVHO and/or substantially of EVOH. According to a second embodiment, the barrier layer consists of at least one fluoropolymer and/or substantially of at least one fluoropolymer. It is particularly preferred that the barrier layer consists solely of a fluoropolymer and/or substantially of solely a fluoropolymer. Preferably the thickness of the barrier layer amounts to 5 to 50%, preferably 10 to 40%, and most preferably 10 to 35% of the total layer thickness of the tube according to the disclosure. It remains within the scope of the disclosure that the barrier layer features barrier properties against at least one component of a motor fuel conducted through the tube.

According to the disclosure, at least one second adhesion-promoting layer is arranged between the barrier layer and the inside layer of the invented tube, and according to one embodiment, solely one second adhesion-promoting layer is so arranged. In an expedient manner, the second adhesion-promoting layer is an adhesion-promoting layer based on at least one polyamide and/or based on at least one polyolefin. If a second adhesion-promoting layer based on at least one polyamide is used, then it is recommended to be an adhesion-promoting layer based on polyamide 6.12. It is expedient to use a modified polyamide, and specifically preferred is a modified polyamide based on polyamide 6.12, for the second adhesion-promoting layer. If the adhesion-promoting layer pertains to an adhesion-promoting layer based on at least one polyolefin, then preferably an adhesion-promoting layer based on polypropylene is used, and in particular one based on a modified polypropylene. The polypropylene herein is modified, for example, with a carbonic acid derivative. According to one recommended embodiment of the disclosure, the thickness of the second adhesion-promoting layer amounts to 3 to 30%, preferably 5 to 20%, and most preferably 5 to 15% of the total layer thickness of the tube. The thickness of the second adhesion-promoting layer preferably amounts to 0.03 to 0.15 mm, and preferably 0.03 to 0.1 mm.

It remains within the scope of the disclosure that an inside layer made of at least one thermoplastic polyurethane (TPU) and/or of at least one partly aromatic polyamide (PPA) is used. Furthermore, It remains within the scope of the disclosure that an inside layer is made of at least one thermoplastic polyurethane (TPU) or substantially of at least one thermoplastic polyurethane (TPU) and/or consists of at least one partly aromatic polyamide (PPA), or substantially of at least one partly aromatic polyamide (PPA), respectively. According to one embodiment, the inside layer consists solely of a thermoplastic polyurethane (TPU) or substantially of solely a thermoplastic polyurethane (TPU), respectively.—It is expedient that the thickness of the inside layer amounts to 5 to 50%, preferably 5 to 45%, and most preferably 7 to 40% of the total layer thickness of the tube. It is recommended that the thickness of the inside layer amounts to 0.05 to 0.45 mm, preferably 0.05 to 0.4 mm, and preferably 0.1 to 0.35 mm. According to one embodiment of the disclosure, the inside layer of the tube is provided with conductivity additives. It remains within the scope of the disclosure that the inside layer is the innermost layer of the tube and thus is the one which is in contact with the fluid media flowing through the tube and/or the fuel flowing through the tube.

One expedient embodiment of the disclosure is characterized in that the thickness of the first adhesion-promoting layer and/or the thickness of the second adhesion-promoting layer is less than the thickness of the outside layer. Furthermore, another recommended embodiment of the disclosure is characterized in that the thickness of the first adhesion-promoting layer and/or the thickness of the second adhesion-promoting layer is less than the thickness of the barrier layer. It is expedient that the thickness of the first adhesion-promoting layer and/or the thickness of the second adhesion-promoting layer is less than the thickness of the inside layer.

According to one proven embodiment of the disclosure, the thickness of the outside layer is greater than the thickness of the barrier layer and/or greater than the thickness of the inside layer. One embodiment of the disclosure is characterized in that the invented tube consists solely of the five described layers (outside layer, first adhesion-promoting layer, barrier layer, second adhesion-promoting layer, inside layer). But fundamentally also additional layers can be provided. For example, an additional adhesion-promoting layer can be employed and/or an additional barrier layer. In principle, at least one additional covering layer can be arranged on the outside layer, and/or the outside layer can be surrounded by an envelope tube.

It is recommended that the motor vehicle tube according to the disclosure—preferably a motor fuel tube—be produced by extrusion or coextrusion of the layers, respectively. The layer components according to the disclosure make possible a simple and less complicated coextrusion. The coextrusion of the layers of the invented tube can be implemented especially at moderate temperatures. With respect to the geometric configuration of the invented tube, different variants are possible. For instance, the invented tube can be produced as a smooth, unprofiled hose or also as a corrugated hose.

The disclosure will be explained in greater detail below, based on exemplary embodiments.

According to a first exemplary embodiment, the outside layer of the invented tube consists of polyamide 12 or substantially of polyamide 12, respectively. It is expedient that the outside layer has a thickness of 0.15 to 0.35 mm.—It remains within the scope of the disclosure that on the inside, against the outside layer there is a first adhesion-promoting layer, which consists preferably of a modified polyamide, in particular of a modified polyamide 6.12 or substantially thereof. It is expedient that this first adhesion-promoting layer has a thickness of 0.03 to 0.1 mm. Furthermore, it remains within the scope of the disclosure that adjoining this first adhesion-promoting layer on the inside, there is a barrier layer which—according to one preferred design embodiment—consists of EVOH or substantially thereof. The barrier layer features expediently a layer thickness of 0.2 to 0.7 mm. It is recommended that adjoining the inside of the barrier layer there is a second adhesion-promoting layer, preferably directly against the barrier layer. This adhesion-promoting layer pertains preferably and in the design embodiment to a second adhesion-promoting layer based on polypropylene. It is expedient that this pertains to a modified polypropylene, and in particular to a polypropylene modified with a carbonic acid derivative. The second adhesion-promoting layer preferably has a thickness of 0.03 to 0.1 mm. According to a proven design embodiment of the disclosure, adjoining the inside of the second adhesion-promoting layer or directly against the inside of the second adhesion-promoting layer, there is an inside layer, wherein the inside layer preferably, and in this design embodiment consists of at least one thermoplastic polyurethane (TPU) or consists substantially thereof. It is expedient that the layer thickness of the inside layer is 0.05 to 0.4 mm. It is recommended that the total layer thickness of the tube amounts to 0.7 to 2.5 mm.

According to a second exemplary embodiment of the disclosure, the outside layer consists of polyamide 6.12 or substantially of polyamide 6.12, respectively. It is recommended that the outside layer has a thickness of 0.15 to 0.35 mm. It is expedient that directly adjoining the inside of the outside layer there is a first adhesion-promoting layer which preferably consists, and in the design embodiment consists of a first adhesion-promoting layer based on a polyamide and in particular based on polyamide 6.12. In this case the polyamide pertains preferably to a modified polyamide or to a modified polyamide 6.12, respectively. It is recommended that the first adhesion-promoting layer has a thickness of 0.03 to 0.1 mm. Preferably and in the second design embodiment, directly adjoining the inside of the first adhesion-promoting layer there is the barrier layer, which as is recommended and as in the second design embodiment consists of a fluoropolymer or substantially of a fluoropolymer, respectively. It is expedient that the barrier layer has a layer thickness of 0.05 to 0.3 mm. It is recommended that the second adhesion-promoting layer is directly adjoining the inside of the barrier layer; the second adhesion-promoting layer in the second design embodiment is based on at least one polyamide, and preferably based on polyamide 6.12. It has proven useful that the second adhesion-promoting layer has a layer thickness of 0.03 to 0.1 mm. It is expedient that adjoining the inside of the second adhesion-promoting layer or directly against the inside of the second adhesion-promoting layer, there is an inside layer, wherein the inside layer preferably, and in the second design embodiment consists of at least one partly aromatic polyamide (PPA) or consists substantially thereof. Preferably the inside layer consists solely of a partly aromatic polyamide (PPA) or substantially solely of a partly aromatic polyamide (PPA). It remains within the scope of the disclosure that the layer thickness of the inside layer amounts to 0.05 to 0.4 mm. It is expedient that the total layer thickness of the tube in the second design example likewise is in the range between 0.7 and 2.5 mm.

The disclosure is based on a knowledge of the fact that the invented motor vehicle tube exhibits a surprisingly high resistance to wash-out of layer components. This applies in particular to the inside layer of the invented tube, but also to the hose layers adjoining thereon. With the invented tube a degree of wash-out of less than 6 g/m² can be obtained with no problem, and surprisingly the degree of wash-out attained according to the disclosure is clearly less than this stated value. Observance of this aforementioned value for the degree of wash-out is demanded by many automobile manufacturers. It should also be emphasized that the invented motor vehicle tube can be employed without problem with different kinds of motor fuels and achieves substantially the same positive results with all these kinds of motor fuels. In contrast to many tubes known from the prior art, the invented tube displays an optimum mechanical resistance, in addition to the outstanding resistance to wash-out, and also a favorable resistance to high and low temperatures. The tube according to the disclosure is highly resistant in the temperature range between −40° C. and +140° C. It should also be emphasized that with regard to these considerable advantages, the invented tube nonetheless can be produced from relatively low-cost materials. An additional advantage to be emphasized is that the invented tube can be easily coextruded, and above all can be coextruded at moderate temperatures. The entire tube according to the disclosure is exceptionally resistant to external chemical influences or to corrosive influences, respectively; for example due to metal chlorides and similar substances. In this regard the invented motor vehicle tube combines a plurality of advantages.

### BRIEF DESCRIPTION OF THE DRAWINGS

The disclosure will be explained in greater detail below with reference to one exemplary embodiment depicted in the figures. The schematic depictions represent:

FIG. 1 a perspective view of a tube according to the disclosure, and

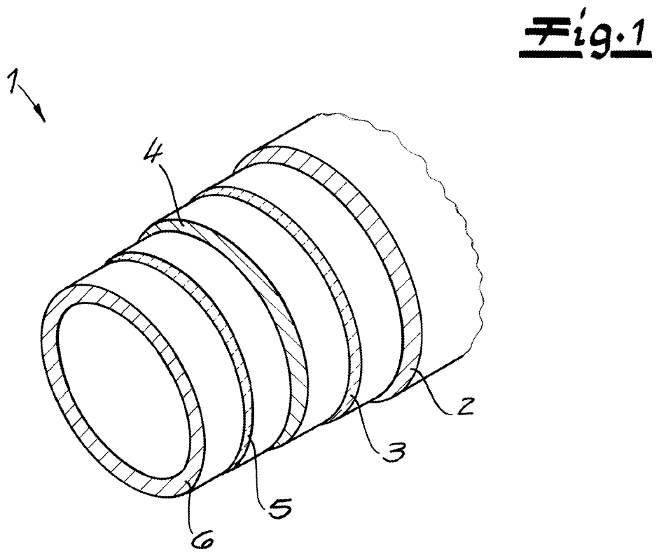

FIG. 2a cross section through the object according to FIG. 1.

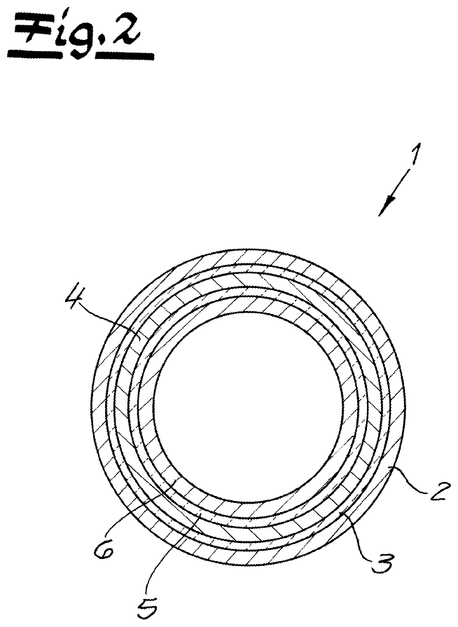

### DETAILED DESCRIPTION

The figures depict one multiple-layer motor vehicle tube (1) according to the disclosure, wherein the exemplary embodiment pertains to a motor fuel tube for conducting of motor fuels. The tube 1 features an outside layer 2, which in the exemplary embodiment consists of polyamide 12 or substantially of polyamide 12. This outside layer 2 may feature a layer thickness between 0.2 and 0.4 mm. Expediently—and as in the exemplary embodiment—a first adhesion-promoting layer 3 is disposed on the inside of the outside layer 2. Preferably—and as in the exemplary embodiment—this adhesion-promoting layer 3 is one based on a modified polyamide 6.12. The layer thickness of the first adhesion-promoting layer 3 in the exemplary embodiment may amount to 0.03 to 0.1 mm.

It remains within the scope of the disclosure that on the inside of the first adhesion-promoting layer 3 there is a barrier layer 4 directly adjoining thereon; in the exemplary embodiment it consists of EVOH or substantially thereof. The thickness of barrier layer 4 expediently amounts to 0.1 to 0.3 mm. As has proven positive—and as in the exemplary embodiment—a second adhesion-promoting layer 5 is disposed on the inside of the outside layer 4. Preferably—and as in the exemplary embodiment—this adhesion-promoting layer 5 is one based on a modified polyamide 6.12. It is recommended that the layer thickness of the second adhesion-promoting layer 5 is 0.03 to 0.1 mm.

According to one preferred embodiment—and as in the design example according to the figures—directly adjoining the inside of the second adhesion-promoting layer 5 there is an inner layer 6, which according to one design variant and as in the exemplary embodiment, consists of a thermoplastic polyurethane (TPU) or substantially thereof. The layer thickness of the inside layer in the exemplary embodiment may amount to 0.1 to 0.4 mm. It remains within the scope of the disclosure that the inside layer 6 can be provided with conductive additives.—Expediently the total layer thickness of the tube amounts to 0.7 to 3 mm, preferably 0.7 to 2.5 mm.

1. Multi-layer motor vehicle tube for conducting at least one fluid medium, wherein the tube features at least five layers and specifically with the following layer structure, from outside to inside:
an outer layer made substantially of at least one polyamide,
a first adhesive layer,
a barrier layer with barrier properties against at least one component of the fluid medium,
a second adhesive layer, and
an inside layer made substantially of at least one thermoplastic polyurethane (TPU) and/or at least one partly aromatic polyamide (PPA),
wherein the total layer thickness of the tube amounts to 0.7 to 3 mm, and wherein the thickness of the first adhesive layer and/or the thickness of the second adhesive layer is less than the thickness of the barrier layer.

2. Multi-layer motor vehicle tube according to claim 1, wherein the outside layer substantially consists of polyamide 12 and/or of polyamide 6.12.

3. Multi-layer motor vehicle tube according to claim 1, wherein the thickness of the outside layer amounts to 5 to 50%, of the total layer thickness of the tube.

4. Multi-layer motor vehicle tube according to claim 1, wherein the first adhesive layer is an adhesive layer based on at least one polyamide and/or based on at least one polyolefin.

5. Multi-layer motor vehicle tube according to claim 1, wherein the first adhesive layer is an adhesive layer based on polyamide 6.12 and/or based on polypropylene.

6. Multi-layer motor vehicle tube according to claim 1, wherein the thickness of the first adhesive layer amounts to 3 to 30% of the total layer thickness of the tube.

7. Multi-layer motor vehicle tube according to claim 1, wherein the barrier layer is a barrier layer based on at least one component from the group “EVOH, fluoropolymer.”

8. Multi-layer motor vehicle tube according to claim 1, wherein the thickness of the barrier layer amounts to 5 to 50% of the total layer thickness of the tube.

9. Multi-layer motor vehicle tube according to one of claims 1 to 8, wherein the barrier layer features barrier properties against at least one component of a motor fuel conducted through the tube.

10. Multi-layer motor vehicle tube according to claim 1, wherein the second adhesive layer is an adhesive layer based on at least one polyamide and/or based on at least one polyolefin.

11. Multi-layer motor vehicle tube according to claim 1, wherein the second adhesive layer is an adhesive layer based on polyamide 6.12 and/or based on polypropylene.

12. Multi-layer motor vehicle tube according to claim 1, wherein the thickness of the second adhesive layer amounts to 3 to 30% of the total layer thickness of the tube.

13. Multi-layer motor vehicle tube according to claim 1, wherein the thickness of the inside layer amounts to 5 to 50% of the total layer thickness of the tube.

14. Multi-layer motor vehicle tube according to claim 1, wherein the inside layer is the innermost layer of the tube and comes into contact with the fluid media flowing through the tube and/or fuel flowing through the tube.

15. Multi-layer motor vehicle tube according to claim 1, wherein the inside layer is provided with conductive additives.

16. Multi-layer motor vehicle tube according to claim 1, wherein the tube is produced by coextrusion.

17. Multi-layer motor vehicle tube according to claim 1, wherein the total layer thickness of the tube amounts to 0.7 to 2.5 mm.

18. Multi-layer motor vehicle tube according to claim 1, wherein the total layer thickness of the tube amounts to 0.8 to 2 mm.
